(19) United States
(12) Patent Application Publication
(10) Pub. No.: US 2025/0244690 A1
(43) Pub. Date: Jul. 31, 2025

(54) PRINT HEAD DEVICE AND IMAGE FORMING APPARATUS PROVIDED WITH SAME

(71) Applicant: SHARP KABUSHIKI KAISHA, Sakai City (JP)

(72) Inventor: Kyohichi MIYAZAKI, Sakai City (JP)

(21) Appl. No.: 19/016,179

(22) Filed: Jan. 10, 2025

(30) Foreign Application Priority Data
Jan. 30, 2024 (JP) 2024-011572

(51) Int. Cl. G03G 15/043

(52) U.S. Cl. CPC G03G 15/043; G03G 2215/0409

(57) ABSTRACT

A print head device including: an active light emitter including light emitting sources formed in at least one row, the light emitting sources each including a drive element and a light-emitting element which emits light at luminance according to a driving current caused to flow by the drive element; a controller that controls each drive element to control light emission and non-light emission of each light emitting source, and luminance during the light emission; and a current detection circuit that detects magnitude of a current, wherein the current detection circuit detects a total driving current of all or a plurality of the light emitting sources as target light emitting sources, and the controller brings the target light emitting sources into a light emitting state, and thereafter determines that the target light emitting sources are defective in a case where the driving current detected by the current detection circuit is less than a predetermined first threshold value.

### CROSS-REFERENCE TO RELATED APPLICATION

The present application claims priority from Japanese Application JP 2024-011572, the content to which is hereby incorporated by reference into this application.

### BACKGROUND OF THE DISCLOSURE

### 1. Field of the Disclosure

The present disclosure relates to a print head device including a plurality of light emitting sources arranged in at least one row, and an image forming apparatus provided with the same.

Each light emitting source includes a light-emitting element that emits light at luminance corresponding to a current and a drive element that operates to allow a drive circuit corresponding to the data signal to flow.

### 2. Description of the Related Art

As a device for exposing a photoreceptor used in an electrophotographic image forming apparatus, in addition to a laser scanning device, a print head device in which a plurality of light emitting sources corresponding to pixels are arranged in one direction (main scanning direction) is known. The print head device is basically a device in which a plurality of LED chips are arranged in one row. The resolution in the main scanning direction is determined by an interval between adjacent LEDs, but it is necessary to ensure an interval between adjacent LED chips during implementation, and therefore a configuration in which a plurality of rows of LEDs arranged such that the positions in the main scanning direction are shifted are arranged in different positions in the sub-scanning direction is also used.

In a case where a laser scanning device is used, it is necessary to secure a certain distance between a photoreceptor as an irradiation surface and a laser light source, and it is also necessary to dispose a scanning optical system. However, by using a print head device, the distance between the photoreceptor and the light emitting source can be shortened, and a compact image forming apparatus can be realized. On the other hand, while a laser scanning device usually requires only one laser light source, a print head device requires tiny light emitting sources arranged at high density, the number of which corresponds to the number of pixels in the main scanning direction.

In recent years, a print head device that uses a configuration of an Organic Light Emitting Device (OLED, also referred to as an organic EL) display has been announced. This is a print head device (hereinafter referred to as an OLED print head device) that uses OLED display technology to implement high density arrangement of many tiny light emitting sources. A light emitter of the OLED print head device, which is a light emitting source of the OLED print head device, is formed on a glass substrate as a TFT panel. The OLED print head device can be produced by applying OLED display manufacturing technology and manufacturing equipment. The configuration of an OLED display in which variation and fluctuation in the characteristics of light emitting sources are compensated within the pixel circuit is known, for example, in the prior art. The configuration of the display device is illustrated in FIG. 1, and the configuration of the pixel circuit in the display device is illustrated in FIG. 2, and these configurations of FIG. 2 are described in the specification. FIG. 6 of the present application corresponds to FIG. 1 of the prior art, and FIG. 7 of the present application corresponds to FIG. 2 of the prior art.

The following technology is known as a method for detecting defects in light emitting sources that use organic electroluminescence (EL) such as an OLED display.

For example, in an OLED display panel inspection method, in order to detect each transistor that changes over time due to a minute leakage current, by using a camera, an external detection apparatus detects a bright spot defect after a predetermined time by turning all the transistors off. The OLED display panel inspection method is a method to detect defects in TFT transistors during manufacturing.

For example, there is known technology for detecting a voltage and a current during driving, and determining that the voltage and the current are unsafe levels and stopping driving in a case where the voltage and the current are outside a predetermined voltage-current range (safety area), in a lighting control device for a single-circuit organic EL panel like a light.

### SUMMARY OF THE DISCLOSURE

An OLED print head device is manufactured using active matrix OLED display manufacturing technology and equipment. In a display device, a circuit that suppresses the variation and the aging of the luminance of each light emitting source and obtains luminance according to a driving current is incorporated into a TFT panel (hereinafter sometimes referred as an active light emitter) formed on a glass substrate together with each light emitting source. However, the display device does not have a circuit to detect a defect related to whether each light emitting source emits light or not. This is because defects related to light emission/non-light emission in the display device can be easily detected by visual inspection or by an inspection device such as a camera (see the prior art). Furthermore, the TFT panel, a driver, and a display control circuit are usually mounted in a single housing and relative positions thereof do not change due to vibration and the like, and therefore it is rare for signal lines to break during use, and there is little need to continuously monitor defects related to light emission/non-light emission. On the other hand, the print head device can recognize defects related to light emission/non-light emission of the light emitting sources as printing results, but there is a possibility that at that point, a developer, a photoreceptor and the like are already damaged. In addition, the photoreceptor is surrounded by movers, including the photoreceptor itself and the developer which are crowded, and vibration is transmitted from these movers. Furthermore, the display control circuit is often disposed away from the TFT panel, which should be located near the photoreceptor, and it is highly desirable to detect defects in the light emitting sources during use, including defects caused by poor connection in a harness connecting the two, and to stop image formation in a case where a defect is detected.

There is a demand to inexpensively detect light emission/non-light emission defects that is not built into the TFT panel of the OLED print head device, outside the TFT panel.

For example, the technology of detecting a defect by an external inspection device by using a camera is intended to be applied to inspection during manufacturing. In a case where the technology is applied to the OLED print head device, an optical detector that detects a defect for each light emitting source is required. However, when such an optical detector is provided separately from the TFT panel, the configuration becomes complicated and the cost burden increases. Furthermore, when the optical detector is incorporated on the TFT panel, the configuration is significantly different from that of the OLED display, and the manufacturing technology and equipment for the OLED display cannot be almost applied as is.

In addition, in a case where the technology for detecting a voltage and a current during operation and determining that the voltage and the current are defective when the voltage and the current are outside the predetermined the voltage-current range (safety area) is applied to the OLED print head device, it is necessary to provide a current detector and a voltage detector corresponding to the light emitting sources. However, the present disclosure is intended to detect defects related to light emission/non-light emission of the light emitting sources, and is not intended to determine whether the voltage and the current are within the safety area or not. When the current detector and the voltage detector are provided, this makes the configuration complicated, and also increases the cost burden.

The present disclosure has been made in consideration of the above circumstances, and provides a method enabling inexpensive detection of defects related to light emission/non-light emission in a print head devices provided with an active light emitters in a mounting state.

The present disclosure provides a print head device including: an active light emitter including light emitting sources formed in at least one row, the light emitting sources each including a drive element and a light-emitting element which emits light at luminance according to a driving current caused to flow by the drive element; a controller that controls each drive element to control light emission and non-light emission of each light emitting source, and luminance during the light emission; and a current detection circuit that detects magnitude of a current, wherein the current detection circuit detects a total driving current of all or a plurality of the light emitting sources as target light emitting sources, and the controller brings the target light emitting sources into a light emitting state, and thereafter determines that the target light emitting sources are defective in a case where the driving current detected by the current detection circuit is less than a predetermined first threshold value.

From a different viewpoint, the present disclosure provides a defect determination method for a print head device including: bringing all or a plurality of light emitting sources as target light emitting sources into a light emitting state; detecting a total driving current of the target light emitting sources by using a current detection circuit; and determining that the target light emitting sources are defective in a case where the driving current detected by the current detection circuit is less than a predetermined first threshold value, by a controller that controls drive elements of an active light emitter including light emitting sources formed in at least one row, the light emitting sources each including a drive element and a light-emitting element which emits light at luminance according to a driving current caused to flow by the drive element.

In the print head device according to the present disclosure, the controller causes the target light emitting sources into the light emitting state, and thereafter determines that the target light emitting sources are defective in the case where the driving current detected by the current detection circuit is less than the predetermined first threshold value. Therefore, it is possible to inexpensively detect a defect related to light emission in the print head device provided with the active light emitter in an attached state.

The defect determination method for a print head device according to the present disclosure also has the same effect.

### BRIEF DESCRIPTION OF THE DRAWINGS

FIG. 1 is an explanatory diagram illustrating a configuration example of a multifunction machine provided with a print head device as an embodiment of an image forming apparatus according to the present disclosure.

FIG. 2 is an explanatory diagram illustrating the image forming unit and the print head device of the multifunction machine illustrated in FIG. 1.

FIG. 3 is a circuit diagram illustrating a configuration of each of OLED elements of the active light emitter and a corresponding TFT circuit in the print head device illustrated in FIG. 2.

FIG. 4 is an explanatory diagram illustrating a configuration of a current detection circuit that detects a driving current of the active light emitter illustrated in FIG. 3.

FIG. 5 is a flowchart illustrating a flow of a process to detect defects of light emitting sources executed by a controller 300 in this embodiment.

FIG. 6 is a block diagram of an overall configuration of a conventional organic EL display device illustrated in the prior art.

FIG. 7 is a circuit diagram illustrating a configuration of a pixel circuit of the conventional EL display device illustrated in FIG. 6.

### DETAILED DESCRIPTION OF THE DISCLOSURE

The present disclosure will be hereinafter described in further detail with reference to the drawings. The following description is illustrative in all respects and should not be construed as limiting the present disclosure.

### Embodiment 1

### Configuration of Image Forming Apparatus

Now, a configuration example of an image forming apparatus provided with a print head device in this embodiment will be described.

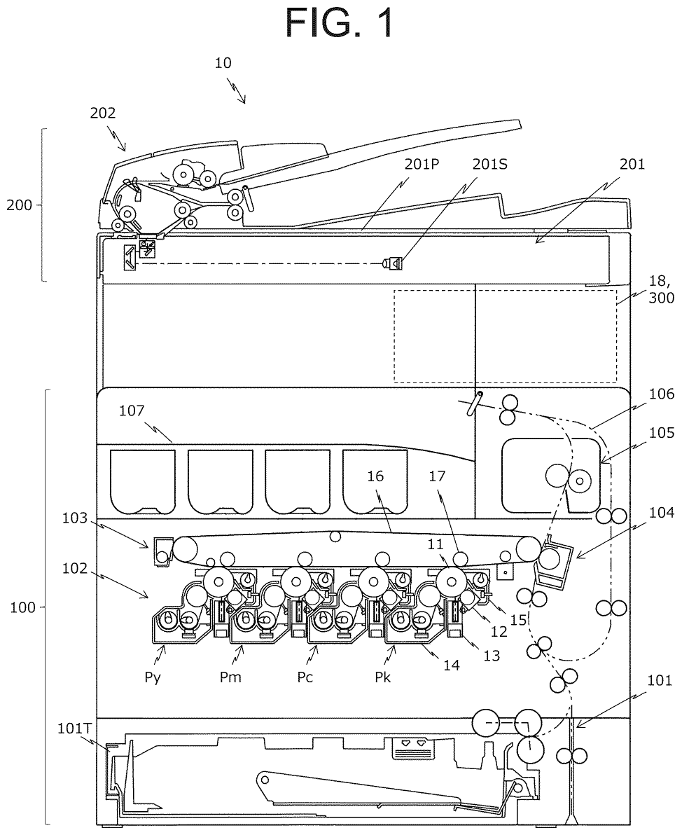

FIG. 1 is an explanatory diagram illustrating a configuration example of a multifunction machine provided with a print head device as an aspect of the image forming apparatus according to the present disclosure. As illustrated in FIG. 1, a multifunction machine 10 includes a scanner 200 that reads a document at an upper portion and an engine 100 that forms an image at a lower portion. The multifunction machine 10 further includes a controller 300 that controls the control the scanner 200 and the engine 100. In the example illustrated in FIG. 1, the controller 300 is mounted on a control circuit 18 disposed at the back between the scanner 200 and the engine 100. The controller 300 is composed mainly of a processor and a memory. In addition to the processor, the control circuit 18 is composed of hardware resources such as an input/output interface circuit, a timer circuit, an image processing circuit, and a communication circuit. The processor executes a control program prestored in the memory, and the controller 300 executes a series of processes related to image formation. Software resources and hardware resources cooperate to realize functions as the controller 300. The functions of the controller 300 may be physically distributed not only in the control circuit 18 but also in a plurality of circuits (circuit substrates), and these circuits may cooperate to function as the controller 300. In this case, the control circuit 18 controls at least the print head device 13 and executes a process related to image formation in the multifunction machine 10 in cooperation with other circuits.

The scanner 200 includes an image reader 201 and a document feeding device 202. The document feeding device 202 is disposed above the image reader 201. The document feeding device 202 transports documents one by one. The image reader 201 reads documents transported one by one by the document feeding device 202 with an image sensor 201S. The scanner 200 can also scan a document placed on a transparent document table 201P facing a bottom surface of the document feeding device 202 and read the document with the image sensor 201S. The scanner 200 generates image data of the read document.

The engine 100 includes a paper feed mechanism 101, an image former 102, an intermediate transferer 103, a secondary transferer 104, a fixer 105, a double-sided transport path 106, and an ejection tray 107. The paper feed mechanism 101 stores printing paper in a paper feed tray 101T and feeds the printing paper used for a print job. The engine 100 illustrated n FIG. 1 uses yellow (Y), magenta (M), cyan (C), and black (K) toners to form color or monochrome images. Therefore, the engine 100 includes an image forming unit Py that forms a yellow toner image, an image forming unit Pm that forms a magenta toner image, an image forming unit Pc that forms a cyan toner image, and an image forming unit Pk that forms a black toner image. Each image forming unit is provided with a photoconductor drum 11 which is a photoreceptor for forming a toner image, a charging roller 12 which is a charger, a print head device 13, a developer 14, and a cleaning mechanism 15. The controller 300 uses these to form an image.

The controller 300 uses the charging rollers 12 to uniformly charge peripheral surfaces of the photoconductor drums 11 to a predetermined potential. The controller 300 uses the print head devices 13 to expose the peripheral surfaces of the photoconductor drums 11, which are charged by the charging rollers 12, to form electrostatic latent images. In addition, electricity of the peripheral surface of each photoconductor drum 11 is eliminated by irradiating the peripheral surface with light. In addition, the controller 300 develops electrostatic latent images formed on the peripheral surfaces of the photoconductor drums 11 by using the developers 14 to form toner images. Through the above series of operation, the respective toner images of the Y, M, C, and K colors are formed on the peripheral surfaces of the photoconductor drums 11. The intermediate transferer 103 includes an intermediate transfer belt 16 and respective intermediate transfer rollers 17 corresponding to the image forming units Py to Pk. The controller 300 transfers the toner images formed on the photoconductor drums 11 to the intermediate transfer belt 16 by using the intermediate transfer rollers 17. Then, the respective toner images transferred from the image forming units Py to Pk are superimposed on the intermediate transfer belt 16 and transported to the secondary transferer 104.

The controller 300 causes the secondary transferer 104 to transfer the toner images on the intermediate transfer belt 16 to the printing paper fed from the paper feed tray 101T. Furthermore, the toner images transferred by the secondary transferer 104 are heated and fixed onto the printing paper by using the fixer 105. In the case of single-sided printing, the controller 300 ejects the printing paper into the ejection tray 107. In the case of double-sided printing, after a first side is printed, the printing paper is switched back just before the ejection tray 107 and guided to the double-sided transport path 106. The printing paper is again guided to the secondary transferer 104 via the double-sided transport path 106, and the toner images are transferred to a second side, and then ejected to the ejection tray 107.

### Configuration of Print Head Device Included in Image Forming Unit

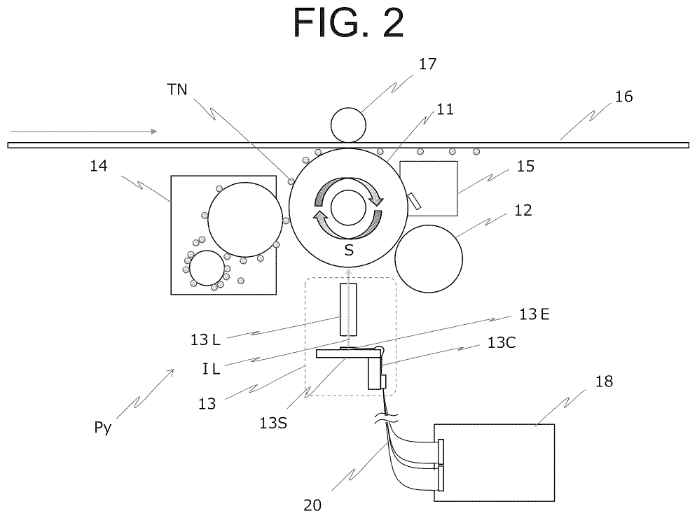

Next, the configurations of the image forming unit in the multifunction machine 10 illustrated in FIG. 1 and the print head device included in the image forming unit will be described. FIG. 2 is an explanatory diagram illustrating the image forming unit and the print head device of the multifunction machine illustrated in FIG. 1. The yellow image forming unit Py is illustrated in FIG. 2 as a representative of the image forming units of each color, but the other colors have a similar configuration. The charging roller 12, the developer 14, the cleaning mechanism 15 and the intermediate transfer belt are illustrated simply, but correspond to those in FIG. 1. The small grey circles highlight toners TN particles. The actual toners TN have smaller diameters and are more numerous.

A portion illustrated in a dashed rectangle in FIG. 2 is the print head device 13. The print head device 13 includes an active light emitter 13E formed on a substrate 13S. Furthermore, the print head device 13 includes an imaging lens 13L that focuses irradiation light IL irradiated from each light emitting source of the active light emitter 13E on the peripheral surface of the photoconductor drum 11. The depth direction of the paper of FIG. 2 is the main scanning direction, and the direction of an arrow S in which the peripheral surface of the photoconductor drum 11 irradiated with the irradiation light IL moves, and which is perpendicular to the main scanning direction, is the sub-scanning direction. The active light emitter 13E is disposed to face the peripheral surface of the photoconductor drum 11 via the imaging lens 13L. The print head device 13 also includes a connector 13C having a connector to connect a signal from the control circuit 18 that controls light emission to the active light emitter 13E. A driver to supply a current to each light emitting source of the active light emitter 13E may be disposed on the substrate 13S or the connector 13C. The connector 13C of the print head device 13 and the control circuit 18 are connected via a signal harness 20.

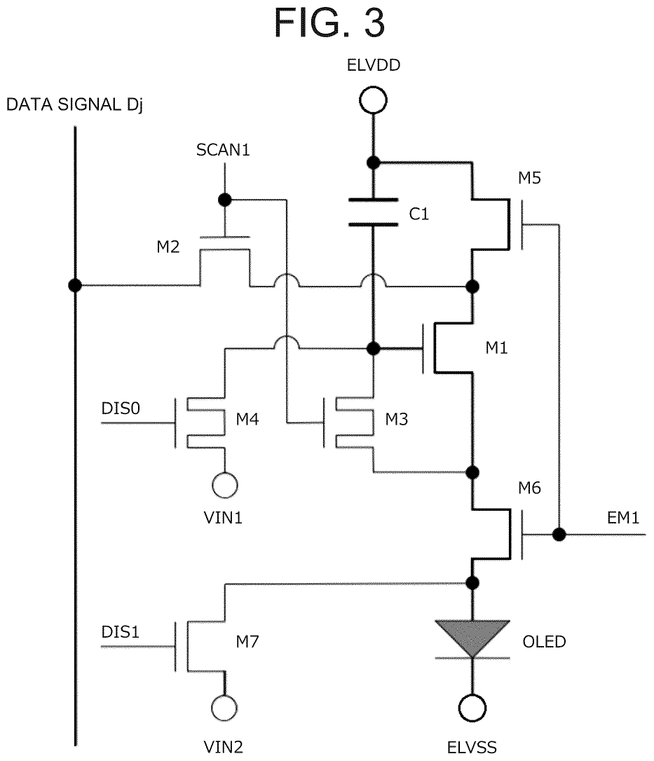

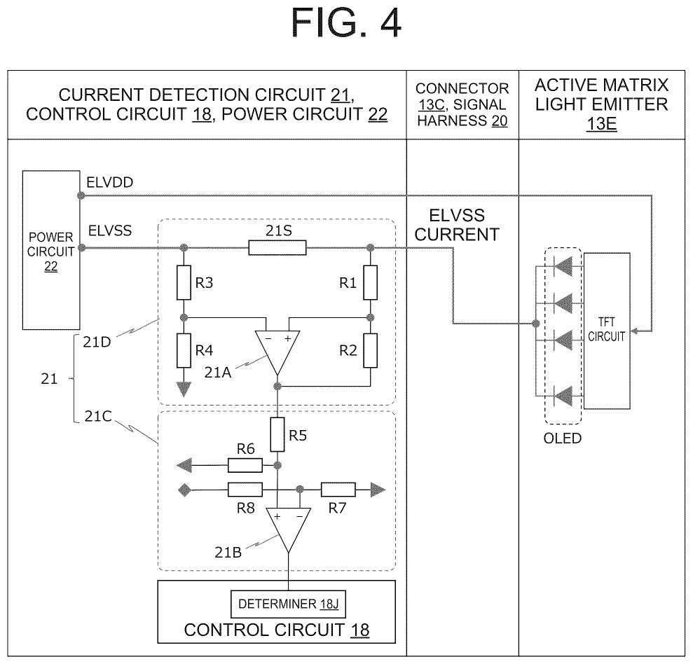

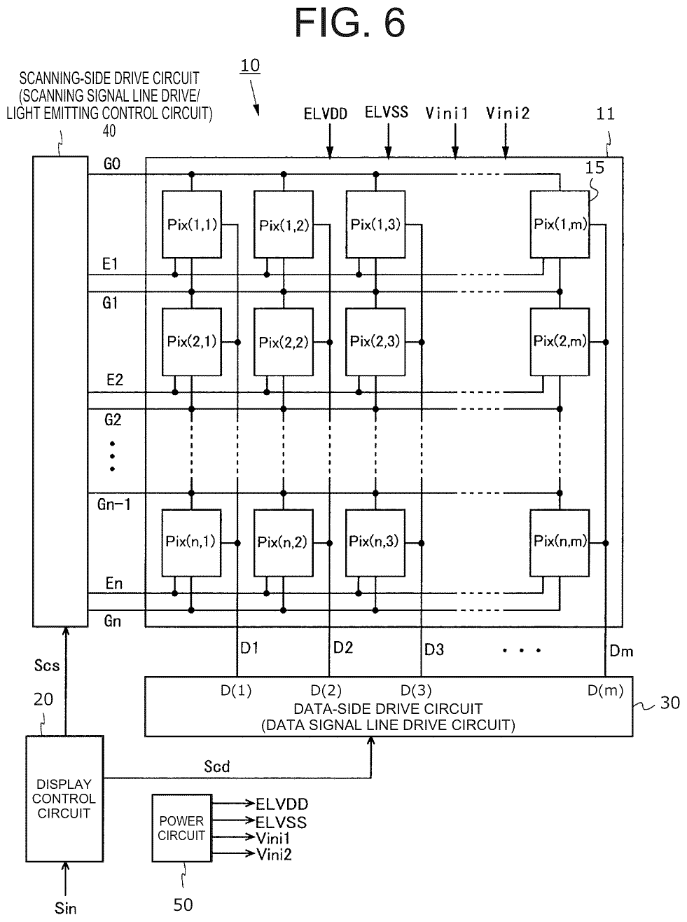

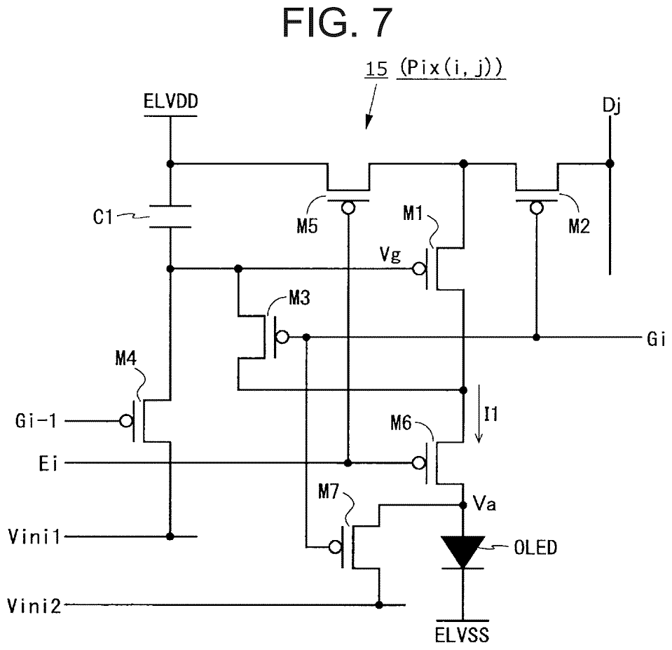

FIG. 3 is a circuit diagram illustrating a configuration of each of OLED elements of the active light emitter 13E and a corresponding TFT circuit in the print head device 13 illustrated in FIG. 2. The OLED element and the circuit illustrated in FIG. 3 substantially correspond to the configuration of a pixel circuit illustrated in FIG. 2 of the prior art. That is, the OLED element, transistors M1 to M7, and a capacitor C1 illustrated in FIG. 3 correspond to an OLED element, transistors M1 to M7, and a capacitor C1 in FIG. 7 (prior art of FIG. 4). Regarding signals, not only signals with the same name but also some signals with different names substantially correspond in FIG. 3 and FIG. 7. For example, SCAN1 in FIG. 3 corresponds to Gi in FIG. 7, EMi in FIG. 3 corresponds to Ei in FIG. 7, and DIS0 in FIG. 3 corresponds to Gi-1 in FIG. 7. The print head device 13 has a configuration in which a plurality of light emitting sources corresponding to the pixel circuits of the prior art are arranged in one row in the one direction (main scanning direction). FIG. 6 illustrates an overall configuration of the display device corresponding to FIG. 1 of the prior art, in which pixel circuits are arranged in a matrix shape, and the configuration of the print head device 13 is substantially equivalent to a configuration in which light emitting sources corresponding to at least one horizontal row of pixel circuits are arranged. However, there is a physical interval between the adjacent OLED elements. Therefore, instead of the configuration in which the OLED elements in the one horizontal row are arranged in the one row in the main scanning direction, a configuration in which OLED elements in a plurality of rows are arranged at different positions in the sub-scanning direction may be used. This configuration enables predetermined resolution in the main scanning direction, that is, the predetermined number of pixels in the main scanning direction, to be achieved even when there is an interval between the adjacent OLED elements. Each row has OLED elements aligned in the main scanning direction that are less than the predetermined number of pixels in the main scanning direction. The positions of the OLED elements in each row in the main scanning direction are shifted from the positions of the OLED elements in other rows. In one example, the number of rows of the OLED elements ranges from 2 to 16.

The drive transistor M1 operates in a saturation region where a drain current is almost constant regardless of a source-drain voltage. Before a light emission period of one cycle, during a data writing period described below, a voltage according to the magnitude of a data signal Dj is stored in the capacitor C1. At that time, the capacitor C1 is charged to compensate for the variation in a threshold value of the drive transistor M1. During a subsequent light-emitting period, the drive transistor M1 causes a driving current with the magnitude according to the voltage held in the capacitor C1 to flow through the OLED element, which is the light-emitting element. The transistors M2 to M7 function as switches.

In detail, the control circuit 18 resets the voltage held in the capacitor C1 at the beginning of each cycle (reset period). When the reset period is started, the control circuit 18 sets an EMi signal to a high level to turn off the transistors M5 and M6. Consequently, the OLED elements are brought into a non-light emitting state. The non-light emitting state continues until the following data writing period ends. During the reset period, the control circuit 18 sets DIS0 to a low level to turn on the transistor M4. This initializes a gate of the drive transistor M1 and one end of the capacitor C1 connected to the gate, to a voltage VIN1 level. This voltage VIN1 is such a level as to be able to keep the drive transistor in an ON state during the data writing period described below.

During the following data writing period, the control circuit 18 sets DIS0 to a high level to turn off the transistor M4. In addition, the data signal Dj is maintained at a voltage according to the light emission intensity (luminance) of the next cycle. Furthermore, a SCAN1 signal is set to a low level to turn on the transistors M2 and M3. Consequently, the drive transistor M1 is in a state in which the gate and a drain are connected, that is, a diode connection state, and the one end of the capacitor C1 connected to the drive transistor M1 is charged until the level of the threshold value voltage of the drive transistor M1 becomes lower than the level of the data signal Dj. The one end of the capacitor C1 is charged in this way, so that a voltage according to the level of the data signal Dj, including compensation for variation and fluctuation in the threshold value voltage of the drive transistor M1 is maintained in the capacitor C1. In addition, during this data writing period, the control circuit 18 sets a DIS1 signal to a low level to turn on the transistor M7. Consequently, an anode of the OLED element is initialized to a voltage VIN2 level and discharges charges stored in the parasitic capacitance of the OLED element.

Then, the control circuit 18 sets the DIS1 signal to a high level to turn off the transistor M7, and sets the EMi signal to a low level to turn on the transistors M5 and M6. This is start of the light emission period. Consequently, each OLED element emits light with the luminance according to the level of the data signal Dj during the data writing period until the reset period of the next cycle starts. For details on the function and the circuit operation of each element, please refer to description in the prior art.

### Configuration of Current Detection Circuit

A current detection circuit that detects defects related to light emission/non-light emission of a light emitting source which is not incorporated in the active light emitter 13E of the print head device 13 in a state in which the print head device 13 is mounted on the image forming unit will be described. FIG. 4 is an explanatory diagram illustrating a configuration of the current detection circuit that detects a driving current of the active light emitter illustrated in FIG. 3 on the ELVSS line side to which the cathode of each OLED element is connected. It is considered that light emission/non-light emission defects of the light emitting sources of the print head device 13 are more likely to be caused by connection between the active light emitter 13E and the connector 13C, or connection between the connector 13C and the control circuit 18, rather than by a defect in the TFT panel.

For the signal connection between the active light emitter 13E and the connector 13C, for example, anisotropic conductive film (also referred to as an AFC) can be used. However, many signal lines are connected at small intervals, and therefore the signal connection does not have high resistance to external force. In addition, each part of the image forming unit, including the print head device 13, is designed to be removable when a service engineer performs maintenance of the multifunction machine 10. It is considered that the photoconductor drum 11 and the developer 14 are replaced periodically, and the print head device 13 is also removed and cleaned at this time. The usage environment is different from that of a display device which is not expected to require periodic attachment and detachment of the TFT panel.

Therefore, in a case where the driving current to each light emitting source is supplied collectively or in a group unit, it is more reasonable to detect light emission/non-light emission defects for each light emitting source by targeting a wiring unit of that driving current, rather than individually detecting each light emitting source. In other words, the light emission/non-light emission defects of the light emitting sources may be determined by detecting the current in the ELVSS line common to all or each group of the light emitting sources, or the current in the ELVDD line. In addition, it may be possible to target the unit of several anisotropic conductive films used for connection between the active light emitter 13E and the connector 13C. Alternatively, it may be possible to target the unit of the signal harness 20 used for connection between the connector 13C and the control circuit 18. In particular, the driving current can be detected with a relatively simple configuration by applying a current detection circuit. In this embodiment, a configuration to detect the driving current will be described.

As illustrated in FIG. 4, a current detection circuit 21 is provided outside the active light emitter 13E. Specifically, an example in which the current detection circuit 21 is disposed in the control circuit 18 is illustrated. However, the present disclosure is not limited to this, and it is also possible to employ a configuration in which the current detection circuit 21 is disposed in the connector 13C. In this embodiment, the control circuit 18 performs a series of processes related to image formation, but it is stated that there is also an embodiment in which the control circuit 18 cooperates with other circuits to realize the functions of the controller 300. For example, in this case, it may be possible to dispose the control circuit in connector 13C without providing the control circuit 18 separately. In other words, it is conceivable that the connector 13C also functions as the control circuit 18, and that the circuit connected via the signal harness 20 in FIG. 2 (the circuit illustrated by the control circuit 18 in FIG. 2) cooperates with other circuit. In that case, the current detection circuit 21 illustrated in FIG. 4 may be disposed in the connector 13C.

As illustrated in FIG. 4, the current detection circuit 21 includes a current detector 21D and a threshold comparator 21C. The current detector 21D is composed of a current detection resistor 21S inserted into the ELVSS line and a differential amplifier that differentially amplifies voltage drop proportional to a current generated at both ends. The differential amplifier is composed of an amplifier 21A which uses an operational amplifier, and resistances R1 to R4. The threshold comparator 21C is a comparator, and is composed of an amplifier 21B which use an operational amplifier and resistance R5 to R8. The resistors R6 and R5 divide a voltage level according to a current output from the current detection circuit 21 and input the voltage to the amplifier 21B, while the resistors R7 and R8 each generate a voltage at the threshold value level. The threshold comparator 21C compares the voltage level according to the current with the threshold value and outputs the resulting determination signal as a two-value voltage, high and low. The control circuit 18 includes a determiner 18J that controls the light emission/non-light emission of each light source, and determines the defects of each light emitting source on the basis of the signal output from the threshold comparator 21C. It is considered that the determiner 18J includes an analog input circuit and includes the function of the threshold comparator 21C. That is, the analog output from the current detector 21D is received by the analog input circuit of the determiner 18J, the determiner 18J performs A/D conversion of the input analog voltage and compares the converted voltage with the threshold value held inside the determiner 18J to determine whether the light emitting source is defective.

As illustrated in FIG. 4, the current detection resistor 21S is inserted in the ELVSS line common to the cathodes of the OLED elements to detect the total driving current of the OLED elements. FIG. 4 illustrates an aspect in which all the OLED elements of the active light emitter 13E are commonly connected to the ELVSS line. In other words, the total driving current of the OLED elements of the active light emitter 13E is the target of detection. Alternatively, it is considered that the cathodes of the OLED elements in several groups are connected in common, and the driving current of the ELVSS line for each group is detected. In this case, the total driving current of each group of the OLED elements is the target of detection. In addition, FIG. 4 illustrates a configuration in which the current detection resistor 21S is inserted in the ELVSS line. However, instead of the above, it is also considered that the current detection resistor 21S is inserted in the ELVDD line.

### Process of Determiner

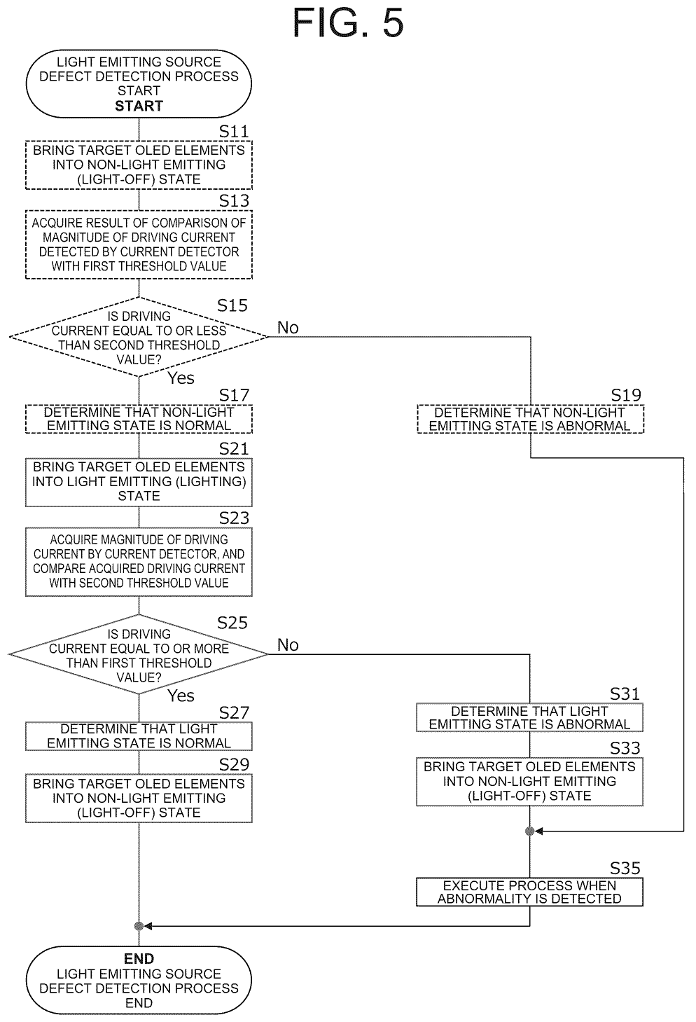

Next, an example of a process in which the determiner 18J of the control circuit 18 (controller 300) illustrated in FIG. 4 determines whether the light emitting sources are defective will be described. FIG. 5 is a flowchart illustrating a flow of processes to detect a defect in light emitting sources, which is executed by the controller 300 as the determiner 18J in this embodiment. The processes of Steps S11 to S19 illustrated in FIG. 5 are processes to detect a defect (light-off defect) in which the target OLED elements emit light even when the target OLED elements are brought into a non-light emitting state. The following processes of Steps S21 to S33 are processes to detect lighting defects in which the target OLED elements do not emit light even when the target OLED elements are brought into in a light emitting state. The processes in Steps S11 to S19 related to the detection of light-off defects are not essential elements and can be omitted. In FIG. 5, the processes that can be omitted are indicated by dashed frames. On the other hand, the processed indicated in Step S21 to S33 are essential elements. In a case where Steps S11 to S19 are omitted, the controller 300 starts the process from step S21.

In accordance with FIG. 5, a process related to the light-off defect will be first described. The controller 300 brings the target OLED elements into a non-light emitting state (Step S11). Generally, the controller 300 controls the data signal Dj to bring the target OLED elements into a light emitting/non-light emitting state. The target OLED elements are OLED elements whose cathodes are connected to the ELVSS line in which the current detection resistor 21S of interest is inserted. In a case where the target OLED elements are in the non-light emitting state, the controller 300 acquires a determination signal output from the current detection circuit 21 (Step S13). Then, it is determined whether or not a driving current is equal to or less than the second threshold value (Step S15). The second threshold value for the detection of lighting defects may be set to a greater absolute value than the first threshold value for the detection of light-off defects.

In a case where the driving current is determined to be greater than the second threshold value (No in Step S15), it is determined that the non-light emitting state of the target light emitting sources is abnormal (Step S19). In other words, even when each light source is brought into a non-light emitting state, it is determined that each light source is in a light emitting state in which the driving current flows. In that case, the controller 300 advances the process to Step S35 which will be described later. On the other hand, in a case where the determination in Step S15 is that the driving current is equal to or less than the second threshold value (Yes in Step S15), it is determined that the target light emitting sources are in a normal non-light emitting state (Step S17). When at least some of the light emitting sources emit light even though the target light emitting sources are brought into the non-light emitting state, the toners TN are developed against intention on the photoconductor drum 11 corresponding to a portion where light emits during an image formation process. The processes indicated in Steps S11 to S19 are used to perform determination of the defect (light-off defect). According to an aspect in which Steps S11 to S19 are performed, defects, in which the target light emitting sources are not in the non-light emitting state even though the target light emitting sources are brough into the non-light emitting state (light-off defects), can be detected in addition to defects, in which the target light emitting sources are not in the light emitting state even though the target light emitting sources are brought into the light emitting state (lighting defects).

Next, the processes of Steps S21 to S33 related to lighting defects will be described. When it is determined in Step S17 that the target light emitting sources are normally in the non-light emitting state, the controller 300 then brings the target OLED elements into the light emitting state (Step S21). The controller 300 acquires a determination signal output from the current detection circuit 21 in a case where the target OLED elements are in the light emitting state (Step S23). Then, it is determined whether the driving current is equal to or more than the first threshold value (Step S25). In a case where it is determined that the driving current is less than the first threshold value (No in Step S25), it is determined that the light emitting state of the target light emitting sources is abnormal (Step S31). That is, even though each light source is in the light emitting state, the driving current does not flow more than the threshold value, and it is determined that at least some of the light source are in the non-light emitting state. In this case, the controller 300 brings the target OLED elements into the non-light emitting state (Step S33) and executes a process when an abnormality is detected (Step S35). Then, the process ends.

On the other hand, in a case where the determination in Step S25 is that the driving current is equal to or more than the first threshold value (Yes in Step S25), it is determined that the target light emitting sources are in the normal non-light emitting state (Step S27). In this case, the controller 300 brings the target OLED elements into the non-light emitting state (Step S29) and ends the process. In a case where at least some of the light emitting sources do not emit light even though the target light emitting sources are in the light emitting state, optical discharging is not performed properly, and unintended charges are accumulated on the photoconductor drum 11. In a case where operation related to image formation is performed, the peripheral surface of the photoconductor drum 11 becomes at an unintended potential, and a developing agent that should be contained in the developer 14 adheres to the peripheral surface of the photoconductor drum 11 or leak into the image forming unit. The processes indicated in Steps S21 to S33 are intended to determine lighting defects in the light emitting sources such that such a situation does not occur.

In a case where it is determined that the target light emitting sources are abnormal, the controller 300 executes, for example, the following process in Step S35 described above. First, in a case where the multifunction machine 10 performs the operation related to the image formation, the operation is stopped. When the image formation operation is continued, the photoconductor drum 11, the developer 14 and the like may be damaged. Then, a process to notify a user of the abnormality in the print head device 13 is performed. For example, a message to inform the user of an abnormality in the print head device 13 is displayed on an operation acceptor (not illustrated).

The above is the flow of the processes in which the controller 300 as the determiner 18J detects defects in the light emitting sources.

### Timing of Determination of Defects of Light Emitting Sources

A preferred time of execution of the light emitting source defect detection process by the controller 300 illustrated in FIG. 5 will be described.

In a preferred first aspect, the controller 300 executes the light emitting source defect detection process before rotating the photoconductor drum 11 in the sub-scanning direction, that is, in a state in which the photoconductor drum 11 stops. The multifunction machine has a driver (not illustrated) in order to rotate the photoconductor drum 11. The driver has a driving motor and a transmission mechanism that transmits the rotation of the motor to the photoconductor drum 11. In addition, the driver has a control circuit and a drive circuit that control the rotation of the motor. The controller 300 controls the rotation and stopping of the driver. The control circuit and the drive circuit may be disposed in the control circuit 18, but may also be disposed in another circuit substrate. When image formation is performed, the controller 300 rotates the photoconductor drum 11.

According to this aspect, with the print head device 13 attached, a defect in the light emitting source can be detected in a state in which a photoreceptor is stopped before the photoconductor drum 11 is driven to form an image. The light emitting source defect is detected in the state in which the photoreceptor is stopped, so that it is possible to avoid the occurrence of a situation in which a developing agent that is not normally present on the photoreceptor adheres due to the light emitting source defect, that is, due to a defective exposure or a discharge error of the photoreceptor, while the photoreceptor is driven and image formation is being performed. Furthermore, it is possible to suppress damage to the photoreceptor and the developer and contamination of the machine inside.

In a second preferred aspect, the controller 300 executes the light emitting source defect detection process in a state before the photoreceptor is charged using the charging roller 12 to form an image, that is, in a state in which the photoconductor drum 11 is uncharged. Even when the photoconductor drum 11 rotates, if the peripheral surface of the photoconductor drum 11 is in an uncharged state, the toners TN or the developing agent of the developer 14 does not adhere to the peripheral surface of the photoconductor drum 11.

According to this aspect, with the print head device 13 attached, a light emitting source defect can be detected in a state which the photoconductor drum 11 is in the uncharged state before the photoconductor drum 11 is charged by the charging roller 12. The light emitting source defect is detected in the uncharged state of the photoconductor drum 11, and therefore it is possible to prevent a developing agent or carriers, which is not normally present, from adhering to the peripheral surface of the photoconductor drum 11 charged due to a light emitting source defect, that is, due to a defective exposure or a discharge error of the photoconductor drum 11. Furthermore, it is possible to suppress damage to the photoconductor drum 11 and the developer 14 and contamination of the inside of the image forming unit.

A third preferred aspect is as follows: The controller 300 controls image formation by the image former 102. In an embodiment in which the controller 300 is distributed, the control circuit 18 including the controller 300 that controls the print head device 13 and the control circuit that controls other parts of the image former 102 may cooperate to form an image. When the power of the multifunction machine 10 is turned on by user operation, or when the controller 300 detects an event that returns from a power saving mode to a normal mode, power is supplied from a power circuit 22 to the image former 102 including the print head device 13. According to this embodiment, after power is supplied to the image former 102, the controller 300 performs the light emitting source defect detection process before the image former 102 starts forming an image.

According to this embodiment, with the print head device 13 attached, a light emitting source defect can be detected between the time when power from the power circuit 22 is supplied to the image former 102 and the time when the image former 102 starts forming an image. The controller 300 detects the light emitting source defect between the time when power is supplied to the image former 102 and the time when the image former 102 starts forming an image, and therefore it is possible to suppress damage to the photoconductor drum 11 and the developer 14 and contamination of the inside of the machine.

The present disclosure should be understood to include any combination of a plurality of the aspects described above.

In addition to the above embodiments, various modifications of the present disclosure are possible. Such variations are not to be construed as falling outside the scope of the present disclosure. The present disclosure should include all variations that are equivalent in meaning to the claims and fall within the scope of the present disclosure.

What is claimed is:

1. A print head device comprising:
an active light emitter including light emitting sources formed in at least one row, the light emitting sources each including a drive element and a light-emitting element which emits light at luminance according to a driving current caused to flow by the drive element;
a controller that controls each drive element to control light emission and non-light emission of each light emitting source, and luminance during the light emission; and
a current detection circuit that detects magnitude of a current, wherein
the current detection circuit detects a total driving current of all or a plurality of the light emitting sources as target light emitting sources, and
the controller brings the target light emitting sources into a light emitting state, and thereafter determines that the target light emitting sources are defective in a case where the driving current detected by the current detection circuit is less than a predetermined first threshold value.

2. The print head device according to claim 1, wherein the controller further perform a process to determine that the target light emitting sources are defective in a case where the controller brings the target light emitting sources into a non-light emitting state, and thereafter a driving current detected by the current detection circuit is more than a predetermined second threshold value.

3. The print head device according to claim 2, wherein the first threshold value has an absolute that is equal to or less than the second threshold value.

4. An image forming apparatus comprising:
the print head device according to claim 1;
a photoreceptor for image formation exposed by the print head device; and
a driver that drives the photoreceptor, wherein
the controller controls the driver or cooperates with a second controller which controls the driver to determine the defect in a state in which the photoreceptor stops before the photoreceptor is driven to form an image.

5. An image forming apparatus comprising:
the print head device according to claim 1;
a photoreceptor for image formation exposed by the print head device; and
a charger that charges the photoreceptor, wherein
the controller controls the charger or cooperates with a second controller which controls the charger to determine the defect in a state in which the photoreceptor is uncharged before the photoreceptor is charged using the charger to form an image.

6. An image forming apparatus comprising:
the print head device according to claim 1;
an image former that includes the print head device, and forms an image by an electrophotographic method; and
a power circuit that supplies power to the image former, wherein
the controller controls image formation by the image former or cooperates with a second controller which controls the image former to determine the defect before the image former forms an image after power from the power circuit is supplied to the image former.

7. A defect determination method for a print head device comprising:
bringing all or a plurality of light emitting sources as target light emitting sources into a light emitting state;
detecting a total driving current of the target light emitting sources by using a current detection circuit; and
determining that the target light emitting sources are defective in a case where the driving current detected by the current detection circuit is less than a predetermined first threshold value,
by a controller that controls drive elements of an active light emitter including light emitting sources formed in at least one row, the light emitting sources each including a drive element and a light-emitting element which emits light at luminance according to a driving current caused to flow by the drive element.
